(19) United States
(12) Patent Application Publication
(10) Pub. No.: US 2009/0137439 A1
(43) Pub. Date: May 28, 2009

(54) Printer Head and Printer Disk Cleaning Compositions and Methods of Use

(76) Inventors: Xuan-Dung Thi DINH, San Jose, CA (US); Chiu Tse, San Francisco, CA (US); Chris Reid, Hamilton (GB)

Correspondence Address: MORGAN LEWIS & BOCKIUS LLP, 1111 PENNSYLVANIA AVENUE NW, WASHINGTON, DC, 20004, US

(21) Appl. No.: 12/239,957

(22) Filed: Sep. 29, 2008

Related U.S. Application Data
(60) Provisional application No. 60/996,656, filed on Nov. 28, 2007.

(51) Int. Cl. C11D 9/02

(52) U.S. Cl. 510/170; 510/109

(57) ABSTRACT

The present invention generally relates to compositions and methods for cleaning by contacting a hard disk data storage device, an inkjet printer cartridge head, or the like having residue thereon, particularly organometallic or metal oxide residue, with a cleaning composition of the present invention for a time and at a temperature sufficient to remove the residue. Stirring, agitation, circulation, sonication or other techniques as are known in the art optionally may be used. The hard disk data storage device, an inkjet printer cartridge head, or the like is generally immersed in the cleaning composition. The time and temperature can be determined based on the particular material being removed from a substrate. Generally, the temperature is in the range of from about ambient or room temperature to about 100° C. and the contact time is from about 1 to about 60 minutes. The preferred temperature and time of contact for this invention is about 25 to about 45° C. for about 2 to about 60 minutes. Generally the hard disk data storage device, an inkjet printer cartridge head, or the like may optionally be rinsed after using the composition or the method may be rinse-free, as such rinse is unnecessary with Al₂O₃. Preferred rinse solutions include isopropanol and/or deionized water.

The present application claims priority to U.S. Provisional Application No. 60/996,656, filed on Nov. 28, 2007, which is incorporated by reference in its entirety.

### FIELD OF THE INVENTION

The present invention generally relates to compositions and methods for cleaning by contacting a hard disk data (HDD) storage device, an inkjet printer cartridge head, or the like having residue thereon, particularly organometallic or metal oxide residue, with a cleaning composition to remove the residue.

### BACKGROUND OF THE INVENTION

In a conventional magnetic storage system, a thin film magnetic head includes an inductive read/write transducer mounted on what is called a “slider.” The slider design incorporates an air bearing surface to control the aerodynamic interaction between the magnetic head and the spinning magnetic disk under the magnetic head. Air bearing surface sliders (“ABS sliders”) used in disk drives typically have a leading edge surface and a trailing edge surface onto which thin film read/write heads are deposited.

In general, sliders are typically manufactured using a process involving a wafer made of a ceramic-like material such as aluminum oxide and titanium carbide, which acts as the embedded magnetic region. The surface area of the wafer is generally divided into rectangular bars, which are usually referred to as slider bars that adjoin one another lengthwise. Each slider bar is further comprised of sliders adjoining one another along the length of the slider bar. In a conventional thin film head wafer process, the trailing edge surfaces of the sliders corresponds to the front side (or top side) of the wafer whereupon the read/write heads are further formed by various thin film processes. Thus, the backside of the wafer establishes the leading edge surfaces of the sliders.

A slider includes an air bearing surface (ABS) including a plurality of separate coplanar pads, a cavity recessed to a certain depth beneath the level of the ABS, and a plurality of steps in which each step is disposed at a level between that of the ABS and that of the cavity. The process includes multiple cycles of masking, etching, and stripping in order to form at least three successively deeper levels, the deepest level being the cavity.

During processing, each slider is etched, generally with a CF₄ plasma, to pattern the Air Bearing Surface (ABS). In doing so, the aluminum oxide is converted to AlF₃ and sputtered off while TiC is chemically etched. During the etch, which is typically a deep etch, heavy residues are deposited. The structure of the device keeps the read/write head within 10 nanometers of the disk. During operation, at spin speeds that may exceed about 7200 rpm, the residues can dislodge and contact the disk, causing damage and device failure. Accordingly, there is a need for a cleaner to remove the residue to prevent such deposition and damage.

Historically, little or no residue removal has been done and the residues have traditionally been tolerated. However, with newer approaches and technologies, such as the “Femto” generation products, the risk of residue fall-off can no longer be ignored or tolerated. Currently, the industry conducts a physical scrub, similar to a PMCP application, with a based such as sodium hydroxide. However, this technique has been very ineffective.

In particular with the Femto generation products, but with other generation products, such as the Nano, during the etch process very large areas of redeposition products build up on the sidewall of the devices, particularly at the corner. There is a need for a residue remover that will inhibit redeposition of etched materials.

Each slider has one side etched as an ABS and there are about 42 sliders per rowbar and 36 rowbars per TIP, which is a SS carrier. The rowbars are bonded to the TIP with a dry film resist layer. Accordingly, the cleaning formulation must be compatible with both the SS carrier and the dry film resist layer. Due to the titanium metallurgy, there is a need for a formulation that is aggressive toward Ti residues and will keep such metallurgies from redeposition. Due to the aluminum metallurgies involved with sliders, there is a simultaneous need for removers that are not aggressive to aluminum metallurgies but effective with aluminum residues.

Similar metallurgies and needs are involved with the manufacture of inkjet printer heads, namely titanium and aluminum containing compounds. Inkjet printer heads may also involve tungsten containing compounds. The term inkjet refers to a printer system that ejects a drop of ink on demand through an opening in the head of a printer cartridge. The ink in an inkjet cartridge is dispensed from the large cartridge reservoir into a much smaller pressurized reservoir where the ink is separated into individual channels. The ink funnels through the channel to the opening in a nozzle plate. Behind this opening is a tiny heater. When the heater reaches a certain temperature, the ink in contact with the heater vaporizes and is ejected out through the nozzle opening. The ejected ink forms a droplet that upon hitting a substrate such as paper, becomes a dot. When many ink droplets or dots are combined in any given pattern, they can form a letter, line, character or symbol. The ejection of the ink drop gives rise to the term inkjet.

To date, most channels through which the ink is distributed to the heaters are defined by photoresist films. Such films are organic films that are deposited on a substrate. The film is then defined using a photo process similar to that of printed circuit boards. In the process, an ink-jet printhead includes a substrate, resistant heaters arranged on the substrate, conductors, a nonconductive heat transfer layer formed on an entire surface of the substrate (the resistant heaters and the conductors), a cavitation layer formed on the nonconductive heat transfer layer, a passage plate to provide an ink chamber corresponding to the respective heaters, and a nozzle plate formed on the passage plate and including a nozzle corresponding to each ink chamber. The conductors and the heaters are formed through dry etching using resist.

In a typical process about the printer head includes about nine layers, with the some involving dry etch and/or ash residues and others involving bulk resist. Switching chemistries is not preferable due to increased processing time, accordingly there is a need for a chemistry that will remove a variety of etch and/or ash residues and strip bulk resist.

The heaters are formed with materials such as TaN, TiN, TiAlN, and WSiN. The conductors are formed with materials such as aluminum (Al) and tungsten (W). The industry trend is to progress to smaller heater films of TaN, TiN, TiAlN, and WSiN. As the substrate decreases in size, such as WSiN, the amount of etching becomes critical. At the same time, the importance and ability to removal of resist and residues remain. Surprisingly, prior art products such as ACT970™ and EKC265™ caused too great an impact on the resistivity of the etched substrate, such as WSiN. Accordingly, there is a need for a suitable resist and residue remover for ink jet printer head applications that will minimize the impact on resistivity while being able to remove etch and ash residues, as well as bulk resist.

It is an object of the present invention to provide methods and compositions for removing resists and residues from new generation hard disk drives, such as Nano, Femto, and others with less than 10 nm clearance between the read/write head and the disk, while inhibiting redeposition of dislodged residues.

It is another object of the present invention to provide methods and compositions that are effective etch residue removers for ink jet printer head applications that will minimize the impact on resistivity of the heaters, such as WSiN, while minimizing etching of metal substrates and conductors, such as Al and W used in the printer head applications.

The present invention addresses this need and provides formulations that provide more effective removal in hard disk drive and printer head applications.

### DESCRIPTION OF EMBODIMENTS

Reference will now be made in detail to various embodiments. In the following detailed description, numerous specific details are set forth in order to provide a thorough understanding of the subject matter presented herein. It will be apparent to one of ordinary skill in the art that the subject matter may be practiced without these specific details. In other instances, well-known methods, procedures, and components have not been described in detail so as not to unnecessarily obscure aspects of the embodiments.

### SUMMARY OF THE PREFERRED EMBODIMENTS

### Hard Disk Drives

An embodiment of the present invention for use in removing resists and residues from sliders comprises: (I) about 5 to about 50% by weight of one or more oxoammonium compounds, preferably hydroxylamine (50% aq) or hydroxylamine derivatives, more preferably hydroxylamine free base (50% aq); (II) about 0 to about 80% by weight of an organic solvent that is not an alkanolamine, preferably selected from sulfoxides, pyrrolidones, polyols, ethers, and amides, most preferably DMSO and NMP; (III) about 5 to about 80% by weight of one or more alkanolamine or quaternary ammonium (strong base), which is important to keep the pH high enough to activate the HDA, preferably a two-carbon linkage alkanolamine, more preferably diglycolamine and monoethanolamine; (IV) about 0 to about 25% by weight of one or more chelating agents, preferably a hydroxybenzene, such as catechol or gallic acid; and (V) water. Other components may be added based on the particular needs of the process, as will be known by one of skill in the art, such as a surfactant, additional corrosion inhibitors—such as copper corrosion inhibitors. The preferred alkaline component other than alkanolamines is a metal ion free base, more preferably a metal ion free quaternary ammonium compound.

The above-referenced formulations are used in a method of removing resists from air bearing surface sliders, wherein the formulations are effective in removing residues from wet and dry etching of titanium carbide and aluminum oxide. Such compositions are effective in preventing redeposition of such titanium and aluminum containing residues while not aggressively etching the titanium and aluminum containing metals in the substrate.

### Printer Heads

One embodiment of the present invention relates to the treatment of the various substrates involved in printer head manufacture where during the process the layers of a printer head are etched and in some applications ashed. The present invention addresses the problem of excessive etching of substrate layers, in particular, the heater and conductors. The heaters and conductors generally comprise TaN, TiN, TiAlN, and WSiN and aluminum (Al) and tungsten (W) respectively. Further, printer head manufacturers use the same compositions when possible for removing bulk resist and etch residues in processing of the other layers. The present invention involves minimizing etching of the printer head substrates, in particular the heater and conductors, while effectively removing resist and etch residue.

Using the compositions of the present invention in printer head treatment, the heater substrate, WSiN etch, for example, is reduced and cleaning performance is improved with the formulations of the current invention. In addition, the conductor etch rate is also reduced. Preferred compositions for the methods of treating printer head substrates according to the present invention comprise 0 percent to about 40 percent by weight of one or more organic solvents that are not alkanolamines, about 5 percent to about 25 percent by weight of one or more oxoammonium compounds, preferably hydroxylamine free base (50% aq), about 20 percent to about 60 percent by weight of one or more alkanolamines, and the balance water. Preferred compositions contained less than about 30% by weight total water, more preferably less than about 20% by weight total water.

In a preferred embodiment the organic solvent is DMSO or NMP, however, other organic solvents such as sulfoxides, pyrrolidones, polyols, ethers, and amides are suitable. In another preferred embodiment the oxoammonium compound is hydroxylamine or includes hydroxylamine. In another preferred embodiment the alkanolamine is or includes triethanolamine, monoethanolamine, 2-(2-aminoethoxy)ethanol, or monoisopropanolamine, or a mixture thereof.

In some embodiments, other components may be used. In some embodiments the composition includes about 2.5 percent to about 10 percent by weight of one or more corrosion inhibitors. In preferred embodiments used in hard disk and printer head cleaning, the preferred corrosion inhibitors are BTA, catechol, and glycolic acid. In particular, such corrosion inhibitors are most effective and help lower WSiN etch when the alkanolamine component is about 40 to about 60 percent alkanolamine.

In some embodiments, the corrosion inhibitor will be unnecessary, particularly where the alkanolamine content is low, for example below about 40 percent by weight.

### BRIEF DESCRIPTION OF THE DRAWINGS

FIG. 1A is a partially sectioned, front elevational view of a magnetic disk drive assembly.

FIG. 1B is a cross section taken along line 1B-1B of FIG. 1A.

FIG. 2 is a perspective view of a slider.

FIGS. 3A-3H show a cross section of the slider along the line 3-3 in FIG. 2 as it processed through successive steps.

FIG. 4 is shows a side elevational view of the slider of FIG. 2 in flight relative to a magnetic disk.

### DETAILED DESCRIPTION OF THE PREFERRED EMBODIMENTS

The present invention relates to methods and compositions for cleaning hard disk drives (HDD) and printer heads from printer jet technology.

### Hard Disk Drives

Size reductions in the HDD manufacturing process have significantly impacted the need for resist and residue removal. Unexpectedly, the prior art cleaners, such as NaOH, no longer are sufficient and the critical spacing of the read/write disk in Nano, Femto, and smaller HDD technologies has caused a critical need for a solution to remove unwanted resists and residues. Moreover, where such resists and residues are removed, redeposition cannot be tolerated in the current critical dimensions. Surprisingly, it has been found that a physical scrub is no longer necessary or is significantly improved with the use of compositions including one or more oxoammonium compounds, preferably hydroxylamines or derivatives, one or more basic compounds, preferably an alkanolamine, a chelating agent, optionally one or more organic solvents, preferably DMSO or NMP, and water.

The preferred amounts and types are: (I) about 5 to about 50% by weight of one or more oxoammonium compounds, preferably hydroxylamine (50% aq) or hydroxylamine derivatives, more preferably hydroxylamine free base (50% aq); (II) about 0 to about 80% by weight of an organic solvent that is not an alkanolamine, preferably selected from sulfoxides, pyrrolidones, polyols, ethers, and amides, most preferably DMSO and NMP; (III) about 5 to about 80% by weight of one or more alkanolamine or quaternary ammonium (strong base), which is important to keep the pH high enough to activate the HDA, preferably a two-carbon linkage alkanolamine, most preferably diglycolamine and monoethanolamine; (IV) about 0 to about 25% by weight of one or more chelating agents, preferably a hydroxybenzene, such as catechol or gallic acid; and (V) water.

An exemplary method for removing resists and etch residues, or both from a slider substrate comprises contacting the slider with a composition according to the invention, containing an effective amount of one or more oxoammonium compounds, one or more metal ion free basic compounds, a chelating agent, water, and optionally an organic solvent.

### Oxoammonium Compound

The oxoammonium compound is typically a reducing agent (i.e., has a reduction potential), must be miscible with water, and has one of the following structures:

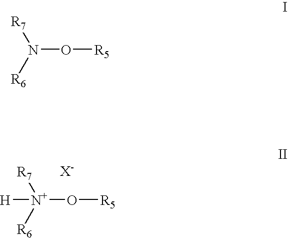

where:

X can be hydroxide; sulfate; hydrogen sulfate; phosphate; hydrogen phosphate; dihydrogen phosphate; nitrate; a carboxylate (e.g., acetate, benzoate, carbamate, formate, lactate, oxalate, hydrogen oxalate, citrate, hydrogen citrate, dihydrogen citrate, tartrate, hydrogen tartrate, gallate (subgallate), cinnamate, or the like); halide, such as chloride, fluoride, iodide, bromide, or the like; carbonate; hydrogen carbonate (bicarbonate); bifluoride; or the like;

each R₅ can independently be hydrogen, a substituted C₁-C₆ straight, branched, or cyclic alkyl, alkenyl, or alkynyl group, a substituted acyl group, straight or branched alkoxy group, amidyl group, carboxyl group, alkoxyalkyl group, alkylamino group, alkylsulfonyl group, or sulfonic acid group, phenyl group, substituted phenyl group, aryl group, substituted aryl group, or a salt or derivative thereof; and

each R₆ and R₇ can independently be hydrogen, a hydroxyl group, a substituted C₁-C₆ straight, branched, or cyclic alkyl, alkenyl, or alkynyl group, a substituted acyl group, straight or branched alkoxy group, amidyl group, carboxyl group, alkoxyalkyl group, alkylamino group, alkylsulfonyl group, or sulfonic acid group, phenyl group, substituted phenyl group, aryl group, substituted aryl group, or a salt or derivative thereof.

Examples of the oxoammonium compound include, without limitation: hydroxylamine, a hydroxylamine sulfate, a hydroxylamine phosphate, hydroxylamine chloride, hydroxylamine nitrate, a hydroxylamine citrate, N,N diethylhydroxylamine, isopropylhydroxylamine, and the like, and combinations thereof.

In preferred embodiments, the oxoammonium compound includes at least one of the following: hydroxylamine (i.e., in formula I, where all of R₅-R₇ are hydrogens), a hydroxylamine salt (i.e., in formula II, where all of R₅-R₇ are hydrogens), and a hydroxylamine derivative (i.e., in formula I, e.g., where R₅ is a hydrogen and where R₆ and R₇ are independently C₁-C₄ alkyl groups). When an oxoammonium salt of formula II is present, a particularly preferred salt counter ion for use in the composition according to the invention is a sulfate, hydrogen sulfate, or nitrate counter ion, although carboxylate, chloride, phosphate, hydrogen phosphate, and dihydrogen phosphate are also preferred salt counter ions.

### Alkaline Component

The desired pH of the composition is usually basic. In certain embodiments, it is desirable for the pH to be maintained and/or modified to be above about 7, for example above about 8 or above about 9. In certain embodiments, it is desirable for the pH to be maintained and/or modified to be in a range from about 7 to about 12, for example from about 8 to about 11.5 or from about 9 to about 11. In a most preferred embodiment, the pH of the composition according to the invention is maintained and/or modified to be at least about 12.

The preferred basic compound is a metal-ion free compound, such as alkanolamines and quaternary ammonium compounds. Suitable alkanolamines can include, but are not limited to, alkanolamines wherein the amine portion is a primary, secondary, or tertiary amine. Preferably, the amine portion of the alkanolamine is a monoamine, a diamine, or a triamine. The alkanol group of the alkanolamines preferably has from about 1 to about 5 carbon atoms. Additionally or alternately, suitable alkanolamines can be represented by the chemical formula R₁₀R₁₁—N—CH₂CH₂—O—R₁₂, wherein each of R₁₀ and R₁₁ can independently be H, CH₃, CH₃CH₂, CH₂CH₂OH, or CH₂CH₂—N—R₁₀R₁₁, and wherein R₁₂ is H or CH₂CH₂OH. Examples of suitable alkanolamines can include, but are not limited to, monoethanolamine (MEA), diethanolamine, triethanolamine, aminoethylethanolamine (AEEA), tertiarybutyldiethanolamine, isopropanol amine, 2-amino-1-propanol, 3-amino-1-propanol, isobutanolamine, 2-amino-2-ethoxypropanol, 2-amino-2-ethoxy-ethanol, which is also known as diglycolamine, and combinations thereof.

Suitable quaternary ammonium compounds include a C₁-C₄ alkyl quaternary ammonium ions such as tetramethylammonium, tetraethylammonium and trimethyl(2-hydroxyethyl)ammonium.

### Chelating Agent

In some embodiments, a chelating agent may be included that will assist with inhibiting the redeposition of residues and at times will inhibit corrosion to certain materials. The chelating agents, when present, generally function to protect a metal (e.g., aluminum, titanium) from being corroded, and may be chosen from a variety of classes of chemical compounds.

More specifically, compounds of the general class:

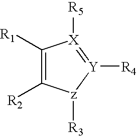

may be employed, where X, Y, and Z are independently chosen from C, N, O, S, P, and mixtures thereof. Under these conditions the valence requirements and presence of pendant R groups may be set appropriately. Pendant R groups R₁-R₅ may each independently include, without limitation: H; substituted C₁-C₆ straight, branched or cyclo alkyl, alkenyl or alkynyl group; straight or branched alkoxy group; substituted acyl group; straight or branched alkoxy group; amidyl group; hydroxyl group; halogen; carboxyl group; alkoxyalkyl group; alkylamino group; alkylsulfonyl group; sulfonic acid group; the salt of such compounds; or mixtures thereof. In one preferred embodiment X, Y, and Z are nitrogen, nitrogen, and carbon, respectively, and R₁-R₅ are each hydrogen. In another preferred embodiment, X, Y, and Z are each nitrogen, R₃ is hydrogen, and R₄ and R₅ are linked together with X and Y to constitute a 6-membered aromatic ring structure.

When present, preferred chelating agents are capable of complexing with materials removed by the compositions according to the invention and may include one or more of amino carboxylic acids such as N-hydroxyethyliminodiacetic acid, nitrilotriacetic acid (NTA), ethylenediaminetetracetic acid (EDTA), N-hydroxyethylenediaminetriacetic acid (HEDTA), and diethylenetriaminepentaacetic acid (DTPA), cyclic carboxylic acids, as well as the salts of amino and cyclic carboxylic acids, such as saturated and unsaturated aliphatic and aromatic mono- and dicarboxylic acids having from 1 to 20, preferably from 2 to 10, more preferably from 2 to 6 carbon atoms, such as, for example, formic acid, acetic acid, propionic acid, butyric acid, caprylic acid, capric acid, lauric acid, myristic acid, palmitic acid, stearic acid, acrylic acid, propiolic acid, methacrylic acid, crotonic acid, isocrotonic acid and oleic acid, cyclohexanecarboxylic acid, benzoic acid, phenylacetic acid, o-, m-, p-toluic acid, o-, p-chlorobenzoic acid, o-, p-nitrobenzoic acid, salicylic acid, phthalic acid, naphthoic acid, cinnamic acid, nicotinic acid, and substituted acyclic and cyclic carboxylic acids such as e.g. lactic acid, malic acid, mandelic acid, salicylic acid, anisic acid, vanillic acid, veratroic acid, oxocarboxylic acids such as e.g. glyoxylic acid, pyruvic acid, acetoacetic acid, levulinic acid; alpha.-aminocarboxylic acids, i.e. all the α-aminocarboxylic acids such as e.g. alanine, arginine, cysteine, proline, tryptophan, tyrosine and glutamine, but also other aminocarboxylic acids such as e.g. hippuric acid, anthranilic acid, carbamic acid, carbazic acid, hydantoic acid, aminohexanoic acid, and 3- and 4-aminobenzoic acid; saturated and unsaturated dicarboxylic acids having from 2 to 20 carbon atoms, such as e.g. oxalic acid, malonic acid, succinic acid, glutaric acid, adipic acid, pimelic acid, suberic acid, azelaic acid, sebacic acid, maleic acid, fumaric acid, phthalic acid, isophthalic acid, terephthalic acid and sorbic acid, and esters of the abovementioned carboxylic acids, among which the methyl, ethyl and ethylhexyl esters should be mentioned in particular.

Another class of chelating agents is the hydroxybenzene class and may be employed in the invention independently or in conjunction with the classes already cited herein. These comprise the general class:

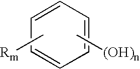

wherein n=1-4, m=2-5 and R is independently hydrogen, a substituted C₁-C₆ straight, branched or cyclo alkyl, alkenyl, or alkynyl group; a substituted acyl group, straight or branched alkoxy group, amidyl group, halogen, carboxyl group, alkoxyalkyl group, aklylamino group, alkylsulfonyl group, or sulfonic acid group, or the salt of such compounds. Suitable specific examples of such chelating agents/corrosion inhibitors include, but are not limited to, mono-, di-, or multi-hydroxybenzene-type compounds, e.g., such as catechol, resorcinol, butylated hydroxytoluene (“BHT”), and the like, or a combination thereof. In one embodiment the chelators include three or more carboxylic acid-containing moieties, e.g., such as ethylenediamine tetraacetic acid (“EDTA”), non-metallic EDTA salts, and the like, or a combination thereof. Compounds containing a two carboxylic acid moieties are less preferred. Compounds containing both hydroxyl and carboxylic acid moieties are useful in one embodiment. Aromatic compounds containing thiol groups, e.g., such as thiophenol; aminocarboxylic acids; diamines, e.g., such as ethylene diamine; polyalcohols; polyethylene oxide; polyamines; polyimines; or a combination thereof, are useful in one embodiment. In one embodiment, one or more chelating agents can be used in one composition, where the chelating agents are selected from groups described above. Alternately or additionally, some chelating agents are described in U.S. Pat. No. 5,417,877, issued May 23, 1995 to Ward, and in commonly assigned U.S. Pat. No. 5,672,577, issued Sep. 30, 1997 to Lee, the disclosures of each of which are incorporated herein by reference. Triazoles, such as benzotriazole may be useful where copper metallurgies are involved. In an alternate embodiment, the composition is substantially free from chelating agents.

The chelating agent is useful in preventing redeposition and assists in “holding” the resist and/or residue in solution after initial removal to prevent redeposition.

### Organic Polar Solvent

In some embodiments, an organic polar solvent that is not an alkanolamine and miscible with water may be included. Suitable organic polar solvents include, non-alkanolamine solvents, such as dimethyl sulfoxide (DMSO), may be suitable for use. Additional examples of organic polarsolvents suitable for use can include, but are not limited to, N-methyl-2-pyrrolidinone, N,N-dimethylpropanamide, N,N-diethylformamide, ethylene glycol, ethylene glycol alkyl ether, diethylene glycol alkyl ether, triethylene glycol alkyl ether, propylene glycol, propylene glycol alkyl ether, dipropylene glycol alkyl ether, tripropylene glycol alkyl ether, N-substituted pyrrolidone, ethylenediamine, and ethylenetriamine, dimethyl acetamide (DMAc), propylene glycol (PG), dipropylene glycol monomethyl ether (DPM), N-methyl pyrrolidone (NMP), or cyclohexyl pyrrolidone (CHP), or mixtures thereof. Additional organic polar solvents miscible with water as known in the art can also be used.

When present in the composition according to the invention, preferred organic polar solvents are typically polar and can include, but are not necessarily limited to, NMP, DMSO, propylene glycol, and mixtures thereof. When present in the composition according to the invention, any solvent used must typically be organic, polar, and largely water-miscible.

In one embodiment, the composition according to the invention can be substantially free from one or more of chelators, corrosion inhibitors, sugar alcohols, film-forming agents, surfactants, abrasive particles, alkanolamines, organic solvents, fluoride-containing compounds, oxidizing agents, reducing agents other than the oxoammonium compound, and metal-containing pH adjusting agents. The phrase “substantially free from,” as used herein in reference to a compound vis-à-vis a composition, should be understood to mean that the composition contains less than about 2% by weight, preferably less than about 1% by weight, for example less than about 0.1% by weight or less than about 0.01% by weight, of the compound. In some cases, the phrase “substantially free from” means that the composition contains none of the compound.

The manufacture of sliders involves many etching, stripping, and residue removal steps. The present invention is to cleaning formulations for use in hard disk drive manufacture (HDD) and a method of using such formulations improving the residue removal process that prevents dislodging of residues and redeposition of such residues, which at the current and future dimensions is critical in preventing failures due to such residues.

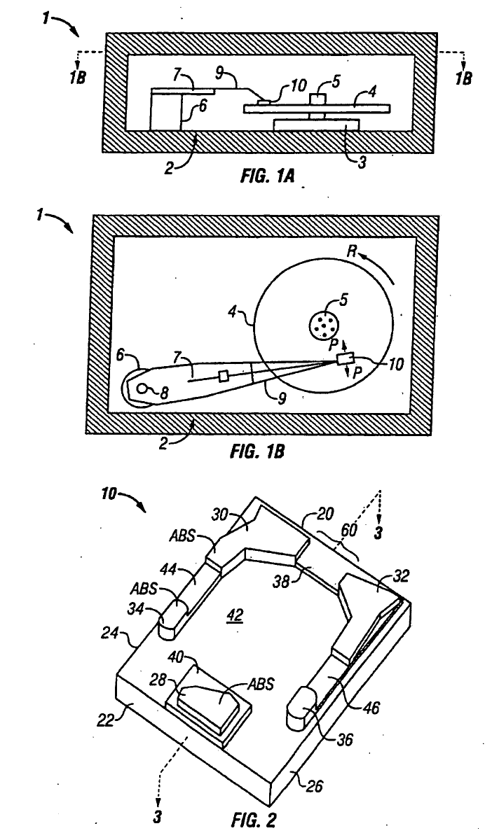

In FIGS. 1A and 1B, a hard disk drive 1 includes a sealed enclosure 2, a disk drive motor 3, a hard disk 4, supported for rotation by a spindle 5 of motor 3, an actuator 6 and an arm 7 attached to a spindle 8 of actuator 6. A suspension 9 is coupled at one end to the arm 7, and at its other end to a read/write head or slider 10. The slider 10 typically includes an inductive write element with a sensor read element. As the motor 3 rotates the disk 4, as indicated by the arrow R, a layer of air proximate to the surface of the disk 4 is swept along with the disk 4. This layer of air, commonly known as windage, pushes against the slider 10 and allows the slider 10 to lift off the surface of the disk 4 and “fly” on an air bearing formed beneath it. Various magnetic “tracks” of information can be read from the disk 4 as the actuator 6 is caused to pivot in a short arc as indicated by the arrows P. The design and manufacture of disk drives 1 is well known to those skilled in the art.

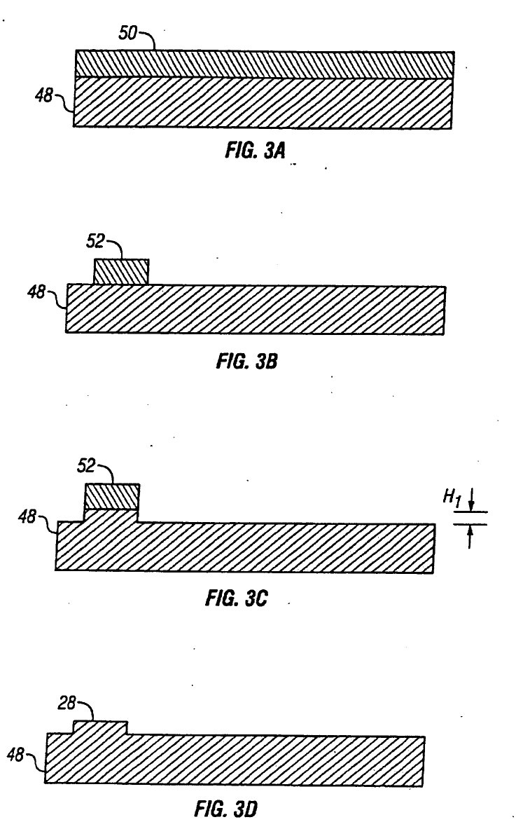

FIG. 2 shows an example of a slider 10. The side of the slider 10 facing up in the drawing is the side that faces the disk 4. Thus, the highest features in the drawing are those that are closest to the disk 4 when the disk drive 1 is in operation. The slider 10 has a generally rectangular shape with a leading edge 20, a trailing edge 22, a first side 24 and a second side 26. Slider 10 further includes an air bearing surface (ABS) comprising a trailing edge pad 28, a first leading pad 30 and a second leading pad 32, and some designs also includes a first side pad 34 and a second side pad 36. The slider 10 additionally includes a leading edge step 38, a trailing edge step 40, and a cavity 42. In some embodiments the slider 10 also includes a first side step 44 and a second side step 46.

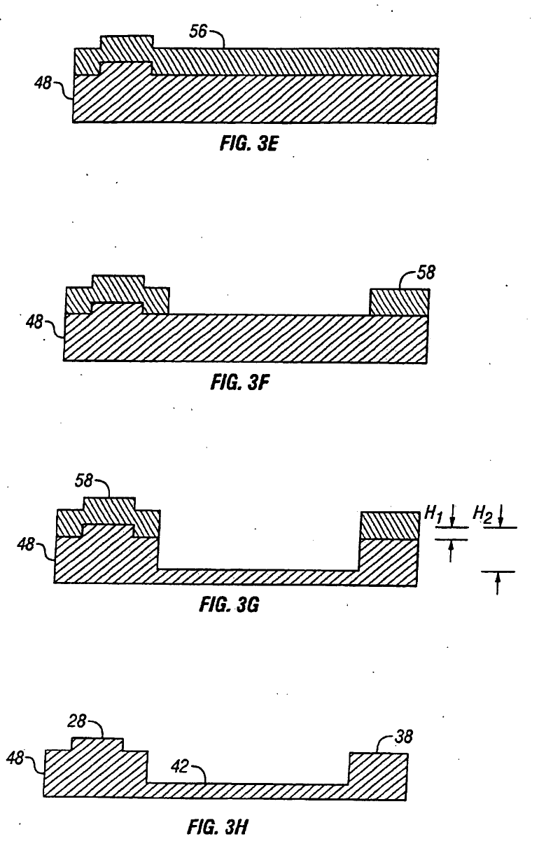

During manufacture, the slider 10 is etched from a single body, typically made of a two phase mixture of aluminum oxide and titanium carbide. The steps of the manufacturing process are generally illustrated in FIGS. 3A-3H and employ photolithography methods that are well known in the art. FIGS. 3A-3H show a cross section of the slider 10 along the line 3-3 in FIG. 2 through successive steps. In FIG. 3A a body 48 that may have a nominally curved surface is covered with a photoresist layer 50. The photoresist layer 50 is patterned and developed, and then any undeveloped material is removed to leave a resist mask 52 as shown in FIG. 3B. Next, the body 48 is etched to remove material that is not protected by the resist mask 52. As shown in FIG. 3C, the etching creates a first surface that is recessed below the level of the initial surface by a depth H₁. FIG. 3D shows the formed trailing edge pad 28 after the first resist mask 52 and etching residues are chemically removed with the formulations of the present invention. The steps of FIGS. 3A-3D are then repeated in FIGS. 3E-3H, again using the formulations of the present invention to remove resists and residues after such steps.

A second photoresist layer 56 is formed over the body 48 as shown in FIG. 3E. The photoresist layer is formed into a second resist mask 58 in FIG. 3F, and the body 48 is again etched in FIG. 3G to create a second surface recessed below the initial surface by a depth H₂. The formulations of the present invention are contacted with the slider to remove the second resist mask and eching residues. FIG. 3H shows the slider 10 after the second resist mask 58 and etch residues have been chemically removed to reveal the leading edge step 38 and the cavity 42.

Accordingly, as can be seen in FIG. 2, slider manufacture includes at least two etching steps to create features at three different heights and after each such step, both resists and etch residues must be removed by chemical cleaning with the formulations of the present invention. Such residues will be complicated and will typically include aluminum oxide and titanium carbide residues, which requires chemistries effective in removing and preventing redeposition of such residues—as well as being effective in removing resist masks.

During operation of the disk drive 1 air that is swept along with the spinning disk 4, commonly known as windage, first encounters the leading edge 20, and leading edge pads 30, 32 and leading edge step 38. As the air flow passes between the leading edge pads 30, 32 and the disk 4 a lifting force is developed that tends to drive the slider 10 away from the disk 4. Another portion of the air flow, however, passes through a gap 60 between the leading edge pads 30, 32, over the leading edge step 38, and over the cavity 42. As the air expands over cavity 42 the pressure drops and a partial vacuum is developed that tends to draw the slider 10 towards the disk 4. In stabile flight, the downward force and the upward force are in equilibrium and the slider 10 maintains a generally constant height above the disk 4, commonly known as the fly height (FH). As recording density increases, the distance (fly height) between the read/write head and the disk has to be decreased. Using the formulations of the present invention reduce problems caused by residues that are not effectively removed and could potentially become dislodged during operation of the HDD under the current technologies.

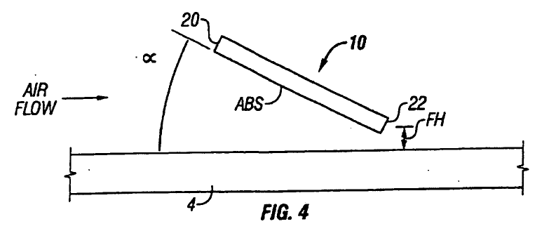

FIG. 4 illustrates an altitude of a slider 10 in stabile flight over a disk 4. The drawing shows how the slider 10 flies with the leading edge 20 elevated relative to the trailing edge 22 such that the plane defined by the ABS forms an angle to the disk 4. The fly height, FH, of the slider 10 is typically defined as the distance between the trailing edge 22 and the disk 4.

One of the current slider technologies, i.e., “pico” ABS, employs Al₂O₃:TiC in a 2:1 ratio. The active (Shield) Region includes various ratios of NiFe protected with a thin layer of Si and DLC (diamond like carbon), 10 and 15 Å respectively. There is a small Al₂O₃ zone exposed at the shield end that is susceptible to attack in fluoride based cleaning compositions.

Femto, which is one of the new ABS technologies, uses similar materials of construction to the current technologies, only in a smaller device. Some applications, however, employ a barrier layer comprising SiN and DLC in similar thickness. Initial results from tests conducted with no other materials having been changed suggest this can be a better barrier layer. Some applications may have different passivation, and some cases may not have any shield area at all.

Improvement in new evaluation may be the result of better uniformity of coverage by the barrier as well as inherently better properties of SiN over Si for such an application. The etch is a combined chemical and physical (sputter) process that deposits very heavy residues with an etch depth of 400-1500 nm. Compositions comprising hydroxylamine, which have a high Ti etch rate, are very good at cleaning this residue.

It will also be appreciated that the present invention is intended to apply equally to variations of slider design and manufacture. Alternative examples of the manufacture of sliders are found in U.S. Pat. No. 6,445,542, which is incorporated by reference as if fully disclosed herein.

Alternative compositions useful in air bearing applications can be found in U.S. Pat. No. 7,205,265 to cleaning compositions and methods of use thereof; U.S. Pat. No. 7,144,849 to cleaning solutions including nucleophilic amine compound having reduction and oxidation potentials; U.S. Pat. No. 7,144,848 to cleaning compositions containing hydroxylamine derivatives and processes using same for residue removal; U.S. Pat. No. 7,051,742 to cleaning solutions including nucleophilic amine compound having reduction and oxidation potentials; U.S. Pat. No. 6,825,156 to semiconductor process residue removal composition and process; U.S. Pat. No. 6,777,380 to compositions for cleaning organic and plasma etched residues for semiconductor devices; U.S. Pat. No. 6,564,812 to alkanolamine semiconductor process residue removal composition and process; U.S. Pat. No. 6,492,311 to ethyenediaminetetraacetic acid or its ammonium salt semiconductor process residue removal composition and process; U.S. Pat. No. 6,399,551 to alkanolamine semiconductor process residue removal process; U.S. Pat. No. 6,367,486 to ethylenediaminetetraacetic acid or its ammonium salt semiconductor process residue removal process; U.S. Pat. No. 6,276,372 to a process using hydroxylamine-gallic acid composition; U.S. Pat. No. 6,242,400 to methods of stripping resists from substrates using hydroxylamine and alkanolamine; U.S. Pat. No. 6,221,818 to hydroxylamine-gallic compound composition and process; U.S. Pat. No. 6,187,730 to hydroxylamine-gallic compound composition and process; U.S. Pat. No. 6,140,287 Cleaning compositions for removing etching residue and method of using; U.S. Pat. No. 6,121,217 to alkanolamine semiconductor process residue removal composition and process; U.S. Pat. No. 6,000,411 to cleaning compositions for removing etching residue and method of using; U.S. Pat. No. 5,902,780 to cleaning compositions for removing etching residue and method of using; U.S. Pat. No. 5,672,577 to cleaning compositions for removing etching residue with hydroxylamine, alkanolamine, and chelating agent; U.S. Pat. No. 5,482,566 to method for removing etching residue using a hydroxylamine-containing composition; U.S. Pat. No. 5,381,807 to methods of stripping resists from substrates using hydroxylamine and alkanolamine; U.S. Pat. No. 5,334,332 to cleaning compositions for removing etching residue and method of using; U.S. Pat. No. 5,279,771 to stripping compositions comprising hydroxylamine and alkanolamine. The compositions of such patents are incorporated herein by reference.

### Printer Head

As with the HDD manufacturing process, size reductions also impact the printer head process. The size reduction is in at least the heater substrate. Previously, the typical best etching rate for a heater substrate, such as WSiN, was about 8 Ω/cm². Although this etching rate is not preferred, it has been tolerated. However, with size reductions, such a loss is no longer tolerable. Unexpectedly, it has been found that formulations containing about 5 to about 25 percent by weight of one or more oxoammonium compounds, such as hydroxylamine (50% aq), selectively achieves the dual and often opposing goals of heater substrate etch rates significantly below about 8 Ω/cm² while also effectively cleaning and stripping the etch residues and resists which are desired to be removed.

### Oxoammonium Compound

In the HDD application, it has been found that amounts from about 5 percent to about 25 percent of the oxoammonium compound are effective. In the printer head application, it was surprisingly found that amounts from about 5 percent to about 25 percent by weight performed superior to higher concentrations, in particular with hydroxylamine free base (HAFB) (50% aq).

### Organic Solvent/Alkanolamine Component

It is preferred that the organic solvent/alkanolamine component is at least part alkanolamine, although other organic solvents may optionally—and in some cases preferably—be used. In the printer head application, at least about 20 percent of an alkanolamine is in the effective compositions, wherein the combination of alkanolamine and organic solvent is from about 20 percent to about 80 percent by weight.

In the printer head application, it was found that high levels of alkanolamine were more aggressive to WSiN, Al, W, and other heater and conductor species in the printer head manufacturing process. However, some amount of alkanolamine—such as 20 percent by weight—was preferred. Where less than 40 percent by weight of alkanolamine was in the composition, the need for a corrosion inhibitor/chelating agent was reduced.

Exemplary alkanolamines include, but are not limited to, monoethanolamine (MEA), 2-(2-hydroxylethylamino)ethanol (i.e., diethanolamine or DEA), 2-(2-aminoethoxy)ethanol (i.e., diglycolamine or DGA), N,N,N-tris(2-hydroxyethyl)-ammonia (i.e., triethanolamine or TEA), isopropanolamine (IPA), 3-amino-1-propanol (i.e., n-propanolamine or NPA), 2-amino-i-propanol (“monoisopropanolamine” or “MIPA”), diisopropanolamine, 2-(N-methylamino)ethanol (i.e., monomethylethanolamine or MMEA), 2-(2-aminoethylamino)ethanol (i.e., aminoethylaminoethanol or AEEA), 2-(N-methylamino)ethanol (“monomethyl ethanolamine” or “NMEA”), 2-[(2-aminoethyl)-(2-hydroxyethyl)-amino]-et-hanol (“N,N-bis-hydroxyethyl-ethylenediamine”), N-aminoethyl-N′-hydroxyethyl-ethyl-enediamine, N,N′-dihydroxyethyl-ethylenediamine, 2-[2-(2-aminoethoxy)-ethy-lamino]-ethanol, 2-[2-(2-aminoethylamino)-ethoxy]-ethanol, 2-[2-(2-aminoethoxy)-ethoxy]-ethanol, tertiarybutyldiethanolamine, isopropanolamine, diisopropanolamine, 3-amino-1-propanol (“n-propanolamine” or “NPA”), isobutanolamine, 2-(2-aminoethoxy)-propanol-, and the like, and combinations thereof.

### Organic Solvents

Examples of such organic solvents include, but are not limited to: amides such as N,N-dimethylformamide, N,N-dimethylacetaamide, N,N-diethylformamide, N,N-diethylacetamide, N-methylformamide, and N-methylacetamide; pyrrolidones such as N-methyl-2-pyrrolidone, N-ethyl-2-pyrrolidone, and N-hydroxyethyl-2-pyrrolidone; imidazolidinones such as 1,3-dimethy-2-imidazolidinone, and 1-3-diethyl-2-imidazolidinone; alkyl ureas such as tetramethyl urea, and tetraethyl urea; polyhydric alcohols and their derivatives such as ethylene glycol, diethylene glycol, or propylene glycol, ethylene glycol monomethyl ether (EGME), ethylene glycol monoethyl ether (EGEE), ethylene glycol monopropyl ether (EGPE), ethylene glycol monobutyl ether (EGBE), propylene glycol monomethyl ether (PGME), propylene glycol monoethyl ether (PGEE), propylene glycol monopropyl ether (PGPE), propylene glycol monobutyl ether (PGBE), diethylene glycol monomethyl ether (DGME), diethylene glycol monoethyl ether (DGEE), diethylene glycol monopropyl ether (DGPE), diethylene glycol monobutyl ether (DGBE), dipropylene glycol monomethyl ether (DPGME), dipropylene glycol monoethyl ether (DPGEE), dipropylene glycol monopropyl ether (DPGPE), dipropylene glycol monobutyl ether (DPGBE), triethylene glycol monomethyl ether, triethylene glycol monoethyl ether, triethylene glycol monopropyl ether, triethylene glycol monobutyl ether, tripropylene glycol monomethyl ether, tripropylene glycol monoethyl ether, tripropylene glycol monopropyl ether, tripropylene glycol monobutyl ether, and mixtures thereof; sulfoxides such as dimethyl sulfoxide, methyl sulfoxide, and diethyl sulfoxide; sulfones such as dimethyl sulfone, diethyl sulfone, bis(2-hydroxyethyl)sulfone, or tetramethylene sulfone; lactams such as N-methyl-2-pyrrolidone, N-ethyl-2-pyrrolidone, N-propyl-2-pyrrolidone, N-hydroxymethyl-2-pyrrolidone, N-hydroxyethyl-2-pyrrolidone, or N-methylpyrrolidinone; imidazolidinones such as 1,3-dimethyl-2-imidazolidinone, 1,3-diethyl-2-imidazolidinone, or 1,3-diisopropyl-2-imidazolidinone; and lactones such as gamma.-butyrolactone or delta-valerolactone. Preferred organic solvents include a sulfoxide, an amide, an ether, or mixture thereof. The most preferred organic solvents are a sulfoxide, e.g., dimethyl sulfoxide (DMSO), or an amide, e.g., an N-alkyl-2-pyrrolidone.

### Chelating Agent

In some embodiments the compositions contain chelating agents in an amount of about 2 to about 15% by weight. It was found that by keeping the alkanolamine content between about 20 to about 40% by weight, the need for a chelating agent or corrosion inhibitor was significantly reduced.

### Organic Acid

Alternately, the compositions may include an organic acid. Organic acid species useful in the composition include but are not limited to formic acid, acetic acid, propanoic acid, butyric acid and the like; hydroxy substituted carboxylic acids including but not limited to glycolic acid, lactic acid, tartaric acid and the like; oxalic acid; carbonyl substituted carboxylic acids including but not limited to glyoxylic acid, and the like; amino substituted carboxylic acids including but not limited to glycine, hydroxyethylglycine, cysteine, alanine and the like; cyclic carboxylic acids including but not limited to ascorbic acid and the like; oxalic acid, nitrilotriacetic acid, citric acid, and mixtures thereof.

### Corrosion Inhibitors

The method and composition may optionally use of one or more corrosion inhibitors. Examples of corrosion inhibitors include, but are not limited to: nitrate salts of ammonium; hydrocarbon-substituted ammonium nitrate salts; benzotriazole; 2,4-pentandione dioxime; 1,6-dioxaspiro[4,4]nonane 2,7-dione(di-ether); thiourea; ammonium bisulfite; choline salts, e.g., bisulfite, nitrate, hydroxide, or the like, or a combination thereof; bischoline salts, e.g., bisulfite, nitrate, hydroxide, or the like, or a combination thereof; trischoline salts, e.g., bisulfite, nitrate, hydroxide, or the like, or a combination thereof; glycerol; sorbitol; gelatine; starch; phosphoric acid; silicic acid; polyethylene oxide; polyethylene imine; benzotriazole; gallic acid or gallic acid esters; glycolic acid or glycolic acid esters; sugar alcohols such as traitol, erythritol, adonitol, xylitol, teritol, idetol, and dulcitol; and the like; and combinations thereof.

Examples of Method of Removing Resists and Residues from HDD

TABLE 1

| Solution | % HDA | % Alkanolamine | % Solvent | % Chelating | % other |
|---|---|---|---|---|---|
| CRX06-255 | 35 | 60 | 0 | 5 | — |
| CRX06-256 | 30 | 55 | 0 | 10 | 5 (DIW) |
| CRX06-257 | 40 | 60 | 0 | 0 | — |
| CRX06-258 | 17.6 | 6 | 0 | 5 | 71.4 (DIW) |
| CRX06-259 | 0 | 0 | 0 | 2 | 97 (DIW + Acid) |
| CRX06-260 | 0 | 0.5 | 65.4 | 0 | 34.1 |
| | | | (DMSO) | | (DIW + Fluoride) |
| CRX06-60 | 25 | 60 | 0 | 5 | 10 (DIW) |
| CRX06-61 | 25 | 0 | 60 (NMP) | 5 | 10 (DIW) |
| CRX06-62 | 30 | 0 | 60 (NMP) | 5 | 5 (DIW) |
| CRX06-63 | 35 | 10 | 50 (NMP) | 5 | — |
| CRX06-64 | 40 | 10 | 50 (NMP) | 0 | — |
| CRX06-65 | 30 | 40 | 0 | 5 | 25 (DIW) |
| CRX06-66 | 30 | 70 | 0 | 0 | 0 |
| CRX06-67 | 30 | 30 | 30 (DMSO) | 0 | 10 (DIW) |
| CRX06-68 | 30 | 30 | 30 (DMSO) | 5 | 5 (DIW) |
| CRX06-69 | 5 | 20 | 0 | 5 | 70 (DIW) |

The HDA expressed above is a 50% aqueous solution

TABLE 2

| Solution | Ti Etch | Clean | Redep |
|---|---|---|---|
| CRX06-255 | Neg. | 9 | 10 |
| CRX06-256 | Neg. | 7 | 10 |
| CRX06-257 | Neg. | 10 | 10 |
| CRX06-258 | Neg. | 3 | 5 |
| CRX06-259 | Neg. | 3 | 5 |
| CRX06-260 | Neg. | 3 | 5 |
| CRX06-60 | Neg. | 8 | 8 |
| CRX06-61 | Neg. | 3 | 8 |
| CRX06-62 | Neg. | 3 | 8 |
| CRX06-63 | Neg. | 8 | 10 |
| CRX06-64 | Neg. | 8 | 8 |
| CRX06-65 | Neg. | 10 | 10 |
| CRX06-66 | Neg. | 10 | 8 |
| CRX06-67 | Neg. | 10 | 8 |
| CRX06-68 | Neg. | 10 | 10 |
| CRX06-69 | Neg. | 5 | 5 |
| | | 10 - completely clean | 10 - No redep, cleaned |
| | | 5 - partially clean | 5 - No Redep, |
| | | | not cleaned |
| | | 1 - not clean | 1 - Redep with clean |

Examples of Method of Removing Resists and Residues from Printer Heads

The following formulations were applied to printer heads coated with photoresist and having been etched such that the substrate to be cleaned contains etch residues in addition to the resist. The ink jet device was treated and evaluated to determine the change in resistance of the WSiN substrate after being treated (unless noted otherwise) for 10 minutes at 70° C. For the purpose of printer head resist and residue removal a change of about 8 ohm/sq is acceptable, a change of about 2 ohm/sq is good; however, more than 10 ohm/sq change in resistivity is not acceptable.

TABLE 3

| | | | WSiN | |
|---|---|---|---|---|
| | Raw | | Resistivity | |
| Formulation | Material | Composition | Change | Comment |
| YDX056 | DGA | 60 | 5.0375 | All photoresist |
| | PG | 15 | | was completely |
| | HDA(50%) | 20 | | removed. |
| | Catechol | 5 | | |
| YDX057 | DGA | 60 | 6.125 | Photoresist and |
| | NMP | 15 | | residue were |
| | HDA (50%) | 20 | | completely |
| | Catechol | 5 | | removed |
| YDX057-1 | DGA | 40 | 2.6125 | Clean and low |
| | NMP | 35 | | WSiN resistivity |
| | HDA (50%) | 20 | | change |
| | Catechol | 5 | | |

Although all formulations showed an acceptable change, it is preferable to use less than 60% alkanolamine, which may alleviate the need for a corrosion inhibitor in the printer head application.

Below are additional formulations tested regarding the printer head process for removal of resists and residues, as well as for etch rates for the heater substrate. Resist and residue removal effects on the substrate, such as WSiN, were assessed by visual comparisons and were all ranked on a scale of 1 to 10, 1 being poor resist and residue removal, 10 being effective resist and residue removal. Generally, a removal efficacy of from 8 to 10 is preferred, with 10 most preferred and less than 7 generally resulting in incomplete removal. The formulations in the tables herein are shown in weight percent, unless otherwise noted.

| | | | | | | Cleaning | | Cleaning |
|---|---|---|---|---|---|---|---|---|
| | | | | WSIN | | Performance | Cleaning | Performance |
| | | | WSIN Etch | Etch | | on | Performance | on |
| | | | (900 Å) | (450 Å) | Process | photoresist | on 900 Å | 450 Å |
| Components | Name | Comp. | Ω/cm² | Ω/cm² | Condition | wafer | process | process |
| HDA(50%) | YDX056 | 20 | 0.46 | 5.04 | 70° C./10′ | 10 | 10 | 10 |
| DGA | | 60 | | | | | | |
| PG | | 15 | | | | | | |
| Catechol | | 5 | | | | | | |
| HDA(50%) | YDX057 | 20 | −0.27 | 6.125 | 70° C./10′ | 10 | 10 | 10 |
| DGA | | 60 | | | | | | |
| NMP | | 15 | | | | | | |
| Catechol | | 5 | | | | | | |
| HDA(50%) | YDX057a | 20 | — | 2.61 | 70° C./10′ | 10 | 10 | 10 |
| DGA | | 40 | | | | | | |
| NMP | | 35 | | | | | | |
| Catechol | | 5 | | | | | | |
| HDA(50%) | YDX058 | 22.5 | −0.31 | 7.2 | 70° C./10′ | 10 | 10 | 10 |
| MEA | | 18.75 | | | | | | |
| MIPA | | 58.75 | | | | | | |
| HDA(50%) | YDX058-1 | 22.5 | 1.59 | 6.8 | 70° C./10′ | 10 | 10 | 10 |
| MEA | | 58.75 | | | | | | |
| MIPA | | 18.75 | | | | | | |
| HDA(50%) | YDX059 | 10 | 14.7 | 16.2 | 70° C./10′ | 7 | 5 | 5 |
| MIPA | | 20 | | | | | | |
| DI | | 20 | | | | | | |
| NMP | | 50 | | | | | | |
| HDA(50%) | YDX060 | 10 | 7.7 | 10.8 | 70° C./10′ | 7 | 5 | 5 |
| DGA | | 20 | | | | | | |
| DI | | 20 | | | | | | |
| NMP | | 50 | | | | | | |
| HDA(50%) | YDX061 | 10 | 24.1 | 25 | 70° C./10′ | 10 | 5 | 5 |
| MEA | | 20 | | | | | | |
| DI | | 20 | | | | | | |
| NMP | | 50 | | | | | | |
| HDA(50%) | YDX062 | 15 | 3.2 | 4.1 | 70° C./10′ | 10 | 10 | 10 |
| DGA | | 45 | | | | | | |
| PG | | 35 | | | | | | |
| Catechol | | 5 | | | | | | |
| HDA(50%) | YDX063 | 10 | 14.8 | 15 | 70° C./10′ | 7 | 5 | 5 |
| DGA | | 35.3 | | | | | | |
| DI | | 20 | | | | | | |
| NMP | | 34.7 | | | | | | |
| DMSO | YDX064-1 | 50 | — | −1.1 | 70° C./10′ | 10 | 8 | 8 |
| HDA(50%) | | 10 | | | | | | |
| DGA | | 20 | | | | | | |
| PG | | 20 | | | | | | |
| DMSO | YDX064-2 | 50 | — | −1.4 | 70° C./10′ | 10 | 10 | 10 |
| HDA(50%) | | 15 | | | | | | |
| DGA | | 20 | | | | | | |
| PG | | 15 | | | | | | |
| DMSO | YDX064-3 | 50 | — | −0.8 | 70° C./10′ | 10 | 6 | 6 |
| HDA(50%) | | 15 | | | | | | |
| DGA | | 15 | | | | | | |
| PG | | 20 | | | | | | |
| DMSO | YDX064-4 | 60 | — | −0.99 | 70° C./10′ | 10 | 6 | 6 |
| HDA(50%) | | 10 | | | | | | |
| DGA | | 15 | | | | | | |
| PG | | 15 | | | | | | |
| DMSO | YDX064-5 | 60 | — | −2.3 | 70° C./10′ | 10 | 10 | 10 |
| HDA(50%) | | 15 | | | | | | |
| DGA | | 20 | | | | | | |
| PG | | 5 | | | | | | |
| DMSO | YDX064-6 | 60 | — | −2.35 | 70° C./10′ | 10 | 5 | 5 |
| HDA(50%) | | 10 | | | | | | |
| DGA | | 10 | | | | | | |
| PG | | 20 | | | | | | |
| DMSO | YDX064-7 | 60 | — | −2.3 | 70° C./10′ | 10 | 5 | 5 |
| HDA(50%) | | 15 | | | | | | |
| DGA | | 10 | | | | | | |
| PG | | 15 | | | | | | |
| DMSO | YDX064T | 50 | — | 0.7 | 70° C./10′ | 10 | 10 | 10 |
| HDA(50%) | | 20 | | | | | | |
| TEA | | 30 | | | | | | |
| DGA | YDX074-1 | 70 | 1.325 | −5.5 | 70° C./10′ | 10 | 10 | 10 |
| HDA(50%) | | 25 | | | | | | |
| Catechol | | 5 | | | | | | |
| DGA | YDX074-2 | 80 | 0.94 | −4.19 | 70° C./10′ | 10 | 10 | 10 |
| HDA(50%) | | 15 | | | | | | |
| Catechol | | 5 | | | | | | |
| HDA(50%) | YDX075 | 20 | 1.34 | −2.61 | 70° C./10′ | 10 | 10 | 10 |
| DGA | | 37.5 | | | | | | |
| NMP | | 37.5 | | | | | | |
| Catechol | | 5 | | | | | | |
| HDA(50%) | YDX075-1 | 20 | — | 2.86 | 70° C./10′ | 10 | 6 | 6 |
| DGA | | 15 | | | | | | |
| NMP | | 60 | | | | | | |
| Catechol | | 5 | | | | | | |
| HDA(50%) | YDX075-2 | 10 | — | 0.075 | 70° C./10′ | 10 | 6 | 6 |
| DGA | | 10 | | | | | | |
| NMP | | 75 | | | | | | |
| Catechol | | 5 | | | | | | |
| HDA(50%) | YDX075-3 | 15 | — | 1.06 | 70° C./10′ | 10 | 6 | 6 |
| DGA | | 10 | | | | | | |
| NMP | | 70 | | | | | | |
| Catechol | | 5 | | | | | | |
| HDA(50%) | YDX076 | 30 | −4.2 | −8.6 | 70° C./10′ | 10 | 10 | 10 |
| DGA | | 60 | | | | | | |
| Glycolic Acid | | 10 | | | | | | |
| HDA(50%) | YDX077 | 20 | −0.825 | −3.8 | 70° C./10′ | 10 | 10 | 10 |
| DGA | | 60 | | | | | | |
| TEA | | 20 | | | | | | |
| DMSO | YDX078 | 50 | −1.28 | −6.4 | 70° C./10′ | 10 | 10 | 10 |
| HDA(50%) | | 40 | | | | | | |
| Catechol | | 10 | | | | | | |
| DMSO | YDX078-1 | 54 | −0.75 | −7.1 | 70° C./10′ | 10 | 10 | 10 |
| HDA(50%) | | 43 | | | | | | |
| BTA | | 3 | | | | | | |
| HDA(50%) | YDX079 | 34 | −9.64 | −13.6 | 70° C./10′ | 10 | 10 | 10 |
| DGA | | 58.2 | | | | | | |
| Catechol | | 4.8 | | | | | | |
| BTA | | 3 | | | | | | |
| DMSO | YDX080 | 50 | 0.725 | 3.2 | 70° C./10′ | 10 | 10 | 10 |
| NMP | | 20 | | | | | | |
| HDA(50%) | | 20 | | | | | | |
| BTA | | 10 | | | | | | |
| MMEA | Comp 1 | 78 | — | 7.2 | 70° C./10′ | 10 | 6 | 6 |
| DI | | 18 | | | | | | |
| BTA | | 2 | | | | | | |
| Gallic Acid | | 2 | | | | | | |
| MMEA | Comp 2 | 76 | | 7.2 | 70° C./10′ | 10 | 6 | 6 |
| DI | | 20 | | | | | | |
| BTA | | 2 | | | | | | |
| Gallic Acid | | 2 | | | | | | |
| DGA | Comp 3 | 60% | −10.1 | −20.2 | 70° C./10′ | 10 | 10 | 10 |
| HDA (50%) | | 35% | | | | | | |
| Catechol | | 5% | | | | | | |

In the method of removing resist and residue from a HDD slider, surprisingly, having no rinse improved the etch rate results. This was unexpected, as traditionally one purpose of the rinse was to prevent continued etching. Although a rinse step may not be preferred, where one is used, preferentially the rinse formulation is substantially deionized water.

### Metals Content

Metals content of the compositions is preferably kept low in order to meet metallic contamination targets known in the art, and expressed in for example the Interconnect section of The International Technology Roadmap for Semiconductors: 2003. Concentration of metals such as Al, Ca, Cr, Cu, Fe, Mg, Mn, Ni, Pb, K, Na, and Zn generally are kept less than 10 ppm, preferably less than 5 ppm, for example less than 1 ppm.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of removing resist masks and residues from an air bearing surface comprising contacting the surface with a composition comprising
about 5% to about 50% by weight of an oxoammonium compound,
about 10 to about 80% by weight of at least one alkaline component which is miscible with said oxoammonium compound and a balance of water,
wherein the residues include residues from etching titanium carbide and aluminum oxide, and
wherein the pH of the composition is greater than 7.

2. The method of claim 1 wherein the composition further comprises about 5 to about 30% by weight of at least one chelating agent.

3. The method of claim 2 wherein said at least one chelating agent is 1,2-dihydroxybenzene or a derivative thereof.

4. The method of claim 1 wherein said at least one alkaline component is an alkanolamine.

5. The method of claim 4, wherein the at least one alkanolamine is selected from the group consisting of monoethanolamine (MEA), diethanolamine (DEA), diglycolamine (DGA), triethanolamine (TEA), isopropanolamine (IPA), n-propanolamine (NPA), monoisopropanolamine (MIPA), monomethylethanolamine (MMEA), aminoethylaminoethanol (AEEA), monomethyl ethanolamine (NMEA), N,N-bis-hydroxyethyl-ethylenediamine, N-aminoethyl-N′-hydroxyethyl-ethyl-enediamine, N,N′-dihydroxyethyl-ethylenediamine, 2-[2-(2-aminoethoxy)-ethyl-amino]-ethanol, 2-[2-(2-aminoethylamino)-ethoxy]-ethanol, 2-[2-(2-aminoethoxy)-ethoxy]-ethanol, tertiarybutyldiethanolamine, isopropanolamine, diisopropanolamine, n-propanolamine (NPA), isobutanolamine, 2-(2-aminoethoxy)-propanol and combinations thereof.

6. The method of claim 5, wherein the at least one alkanolamine is DGA.

7. The method of claim 1 wherein the alkaline component is a quaternary ammonium compound.

8. The method of claim 1 wherein the oxoammonium compound is hydroxylamine and the alkaline component is an alkanolamine.

9. The method of claim 1, wherein the residues further include residues from barrier layers comprising SiN and diamond-like carbon (DLC).

10. A method of removing resist masks and residues from an air bearing surface comprising contacting the substrate with a composition comprising
(a) about 5% to about 50% of hydroxylamine free base;
(b) about 10 to about 80% by weight of one or more alkanolamines and organic solvents; and
(c) water,
wherein the air bearing surface is not mechanically cleaned as part of cleaning process,
wherein at least 10% of component (b) is an alkanolamine; and
wherein the residues include residues from etching titanium carbide and aluminum oxide.

11. The process of claim 10, wherein there is no rinse step immediately following contacting the air bearing surface with said composition.

12. A method for removing residues from a printer head comprising contacting the printer head with a composition comprising
(a) about 5% to about 25% by weight of an oxoammonium compound;
(b) about 20 to about 80% by weight of one or more alkanolamines and organic solvents or mixtures thereof; and
(c) the total amount of water is less than 30% by weight,
wherein said residues include residues from etching a compound selected from the group consisting of TaN, TiN, TiAlN, and WSiN.

13. The method of claim 12, wherein component (a) is hydroxylamine free base in a 50% aqueous solution.

14. The method of claim 12, wherein component (b) contains from about 20% to about 40% by weight of an alkanolamine.

15. The method of claim 12, further comprising from about 2 to about 15% by weight of a chelating agent.

16. The method of claim 12, wherein the residues further include residues from barrier layers comprising SiN and diamond-like carbon (DLC).
